(19) United States
(12) Patent Application Publication
(10) Pub. No.: US 2011/0022581 A1
(43) Pub. Date: Jan. 27, 2011

(54) DERIVED STATISTICS FOR QUERY OPTIMIZATION

(76) Inventor: Rama Krishna Korlapati, El Segundo, CA (US)

Correspondence Address: JAMES M. STOVER;TERADATA CORPORATION, 10000 INNOVATION DRIVE, DAYTON, OH, 45342, US

(21) Appl. No.: 12/509,610

(22) Filed: Jul. 27, 2009

(51) Int. Cl. G06F 17/30

(52) U.S. Cl. 707/713; 707/E17.017

(57) ABSTRACT

A method and system for maintaining derived statistics within a database system. The method includes associating initial statistical information with at least one relation within the database system; composing derived statistics involving the at least one relation; deriving distinctiveness information including at least one relation; and augmenting the derived statistics with the derived distinctiveness information. The derived statistics are associated with the at least one relation. The initial statistical information and the derived statistics are exposed to a query optimizer.

### FIELD OF INVENTION

The invention relates to a method and system for maintaining derived statistics within a database system.

### BACKGROUND TO THE INVENTION

Many database systems include a query optimizer. An essential task of the query optimizer is to produce the optimal execution plan among many possible plans. The optimal execution plan is typically the plan with the lowest cost. The basis on which costs of different plans are compared with each other is the cost derived from the estimation of sizes or cardinalities of temporary or intermediate relations. These temporary or intermediate relations are typically created after operations such as selections, joins and projections.

Estimations in some database systems are derived primarily from user collected statistics and/or random samples of processors in a distributed database. These statistics and samples reflect the base table demographics that can give reasonable estimations for the predicates on the base table.

One difficulty arises when reverting to the original interval histogram statistics at the beginning of each stage of the optimization process. The optimizer does more operations such as joins, aggregations and so on that causes a multiplicative error propagation. Such error propagations often produce significantly less accurate cardinality estimations. Although the initial error may be negligible for the first operation such as a join between two base tables, the subsequent errors can grow very rapidly.

It would be particularly desirable to provide a mechanism or technique to dynamically adjust and propagate base table demographics to joins, aggregations and other operations.

### SUMMARY OF INVENTION

Described below are techniques for maintaining derived statistics within a database system. In one embodiment the preferred form method includes associating initial statistical information with at least one relation within the database system; composing derived statistics involving the at least one relation; deriving distinctiveness information including at least one relation; and augmenting the derived statistics with the derived distinctiveness information. The derived statistics are associated with the at least one relation. The initial statistical information and the derived statistics are exposed to a query optimizer.

In another embodiment the invention provides a computer readable medium having stored thereon computer executable instructions that when executed on a computing device cause the computing device to perform a method of maintaining derived statistics within a database system.

### BRIEF DESCRIPTION OF FIGURES

FIG. 1 shows a sample architecture for part of a database within which the invention operates.

FIG. 2 shows a simplified flow chart that illustrates deriving statistics.

FIG. 3 illustrates a process for propagating a DISTINCT attribute across a join.

FIG. 4 shows a flowchart illustrating how the optimizer uses derived statistics to more accurately estimate cardinalities for a query.

### DETAILED DESCRIPTION

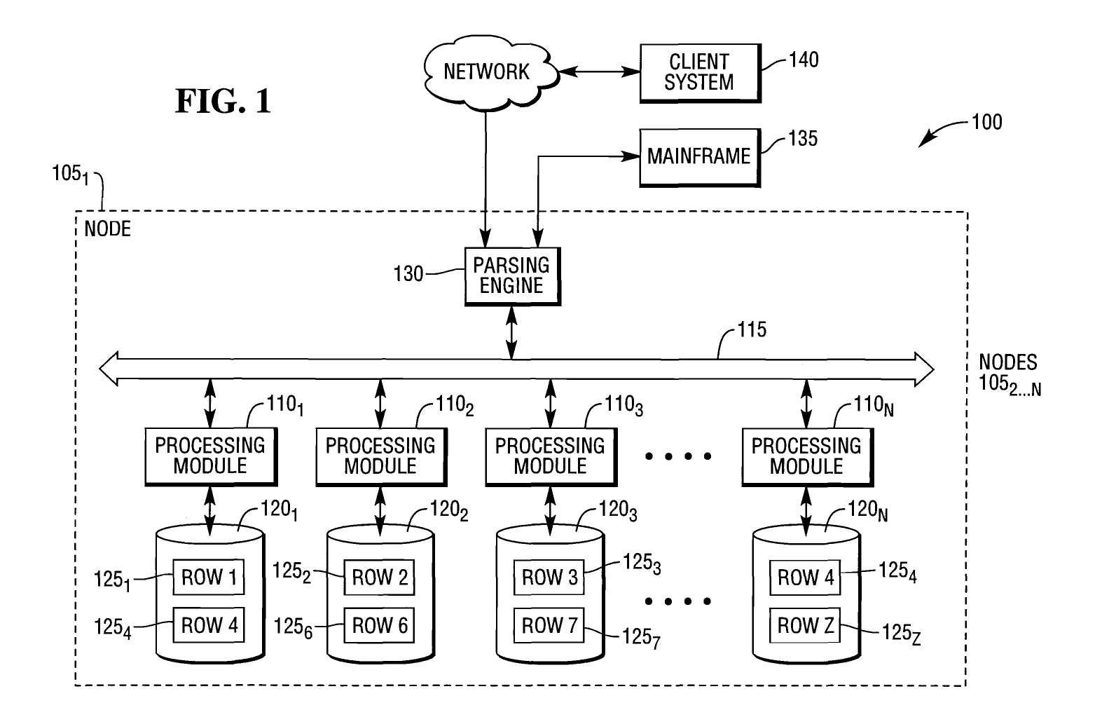

The techniques for maintaining derived statistics have particular application but are not limited to large databases that might contain many millions or billions of records managed by a database system (DBS) 100, such as a Teradata Active Data Warehousing System. FIG. 1 shows a sample architecture for one node 105₁ of the DBS 100. The DBS node 105₁ includes one or more processing modules 110_{1 . . . N} connected by a network 115. The processing modules manage the storage and retrieval of data stored in data storage facilities 120_{1 . . . N}. Each of the processing modules in one form comprise one or more physical processors. In another form they comprise one or more virtual processors, with one or more virtual processors running on one or more physical processors.

Each of the processing modules 110_{1 . . . N} manages a portion of a database that is stored in corresponding data storage facilities 120_{1 . . . N}. Each of the data storage facilities 120_{1 . . . N} includes one or more disk drives. The DBS may include multiple nodes 105_{2 . . . N} in addition to the illustrated node 105₁, connected by extending the network 115.

The system stores data in one or more tables in the data storage facilities 120_{1 . . . N}. The rows 125_{1 . . . Z} of the tables are stored across multiple data storage facilities 120_{1 . . . N} to ensure that the system workload is distributed evenly across the processing modules 110_{1 . . . N}. A parsing engine 130 organizes the storage of data and the distribution of table rows 125_{1 . . . Z} among the processing modules 110_{1 . . . N}. The parsing engine 130 also coordinates the retrieval of data from the data storage facilities 120_{1 . . . N} in response to queries received from a user at a mainframe 135 or a client computer 140. The DBS 100 usually receives queries and commands to build tables in a standard format, such as SQL.

The rows 125_{1 . . . Z} are distributed across the data storage facilities 120_{1 . . . N} by the parsing engine 130 in accordance with a primary index. The primary index defines the columns of the rows that are used for calculating a hash value. The function that produces the hash value from the values in the columns specified by the primary index is called the hash function. Some portion, possibly the entirety, of the hash value is designated as a hash bucket. The hash buckets are assigned to data-storage facilities 120_{1 . . . N} and associated processing modules 110_{1 . . . N} by a hash bucket map. The characteristics of the columns chosen for the primary index determine how evenly the rows are distributed.

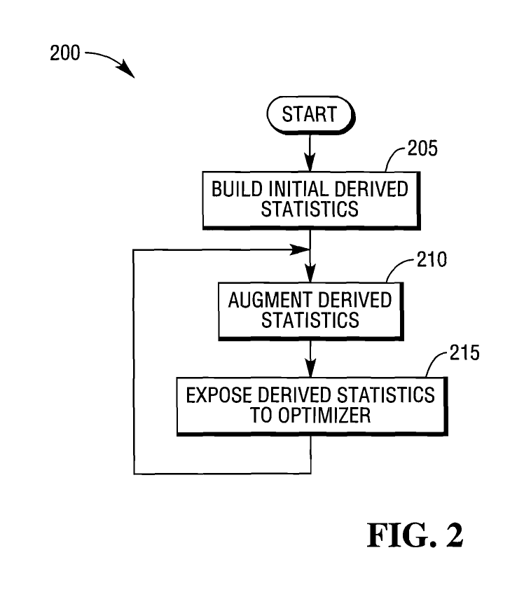

FIG. 2 shows a simplified flow chart that details the major steps in maintaining derived statistics within a database system such as the database system described above with reference to FIG. 1. The techniques described below include derived statistics that dynamically adjust and provide a centralized repository of data demographic information for all estimation and costing modules. These estimation and costing modules include single-table selectivity estimation, join and aggregate cardinality estimation, skew detection, join costing and so on.

The first step is to build 205 initial derived statistics. At the first stage of query optimization, the information in the derived statistics will be identical to the statistical information associated with respective base tables stored in the interval histograms.

The initial derived statistics draw information from several different sources. These sources include demographics derived from histograms acquired using the collect statistics command as well as random AMP samples. Additional sources further include inferred demographics from check constraints and inferred demographics from referential integrity. The initial derived statistics are augmented with additional inherited demographics as will be described below. It is anticipated that new sources of demographics can be added or augmented easily to the derived statistics without changing any optimizer code.

It will be appreciated that in some situations the demographics derived from these multiple sources can be conflicting. It is anticipated that the technique includes a process for cleaning the inaccuracies and inconsistencies from the available demographics after the initial gathering. It is anticipated that this process of resolving conflicts is performed as needed and in this case is performed either following or during the process of building the initial derived statistics.

The optimizer automatically and dynamically adjusts or augments 210 the derived statistics after major optimizer operations. These operations include applying a single table predicate, performing a binary join and performing an aggregation. It is anticipated that the derived statistics include dynamically adjusted information such as the minimum, maximum and best number of unique values, number of nulls, high modal frequency, original interval histogram statistics and uniqueness flags.

Applying Single-Table Predicates

The demographics such as the number of unique values, high mode frequency, number of nulls and so on of the columns having single-table predicates are automatically adjusted after applying a single-table predicate.

One example is the following query:
SELECT*FROM t1, t2 WHERE t1.d1=t2.d2 AND d1 IN (1, 2, 3, 4);

Once the query is applied to the table it is possible to derive the number of unique values for the column d1 from the single-table predicate of this query. The number of unique values in this case is 4. This step can also be performed even in the absence of statistics on column d1.

A further example is where the demographics such as the number of unique values, high mode frequency, number of nulls and so on of the multi-column statistics are adjusted based on the single-table predicates. In this example it is assumed that multi-column statistics have been collected on (c1, d1). The following sample query is applied to the tables:
SELECT*FROM t1, t2 WHERE t1.d1=t2.d2 AND t1.c1=t2.c2 AND t1.c1>10;

In the above query, the system adjusts the demographics of (c1, d1) based on the single-table predicate “t1.c1>10”. The adjusted demographics are used in join cardinality estimation.

For the above example, if the single-table predicate is an equality predicate, for example “t1.c1=10”, then the new demographics will be derived for the single column t1.d1 using the multi-column statistics on (c1, d1).

A further example for augmenting derived statistics following single-table predicate uses intractable column correlation. These column correlations are represented by value mappings such as x→y:1→5. This means for every value of “x” there are 5 values of “y”.

One sample query is:
SELECT*FROM t1, t2 WHERE t1.d1=t2.d2 AND t1.c1=10;
   If the user given or system derived columns correlations are available, the demographics are adjusted after applying a single-table or join predicate.

If the value mapping between c1 and d1 is 1→5, after applying the single-table predicate on c1, the number of unique values of d1 are adjusted to 5.

### Performing a Binary Join

A further major stage for augmenting or adjusting derived statistics is after doing a binary join. One example uses intractable column correlation such as that described above with reference to applying a single-table predicate. The demographics are adjusted after applying the join predicate in the same way as that described above.

In some cases the demographics of the join columns are adjusted following a join predicate based on min-match theory. This theory is the minimum number of values that will find the match. An example query is:
SELECT x1, y1, COUNT(*) FROM t1, t2 WHERE t1.x1=t2.x2 AND t1.y1=t2.y2;

It is assumed that the number of values for (x1, y1)=100 and the number of values for (x2, y2)=50.

The optimizer adjusts the number of unique values of (x1, y1) to 50 and propagates that value to the join result for use in the next stage of the join ordering process.

After Doing Aggregation

The demographic information such as high mode frequency, number of nulls, etc. are adjusted after doing the aggregation for grouping columns.

An example query is:
SELECT t1.x1, t1.y1, COUNT(*) FROM t1, t2 WHERE t1.x1=t2.x2 AND t1.y1=t2.y2 GROUP BY 1,2;

In the above example, since the grouping columns would be unique after aggregation, the high mode frequency, number of nulls of (x1, y1) are adjusted 1. Also, some default demographics for the aggregated information (count(*) in this example) is generated based on some defined heuristics.

Aggregation and Duplicate Elimination

A further technique in which derived statistics are augmented involves aggregation and duplicate elimination. This elimination can be performed for several different reasons. These reasons include processing “SELECT DISTINCT . . . ” or “SELECT . . . FROM . . . GROUP BY . . . ”. Duplicates are eliminated after a SET operation such as UNION/INTERSECT/MINUS. Duplicates are also eliminated from a sub query and so on. Following any of these operations, the distinctness of the attributes are derived and recorded in the derived statistics. This information is used later on for cardinality and costing decisions.

In some cases the attribute may not have any prior demographics information. The techniques described below automatically derive the necessary demographics based on the declared distinctness or distinct operation performed. These operations include aggregation, unique set, DISTINCT, and so on.

Sources of distinctness include unique indexes and derived distinctness after a DISTINCT operation. Unique indexes include declared unique primary indexes and declared unique secondary indexes. Examples of distinct operations include marking grouping columns as distinct after an aggregation. After processing the “select DISTINCT . . . ”, the combination of all projections are marked as DISTINCT. After processing a DISTINCT set operation, the combination of all the projections are marked as DISTINCT.

The DISTINCT attribute is propagated through operations such as joins where applicable and also propagated across query blocks.

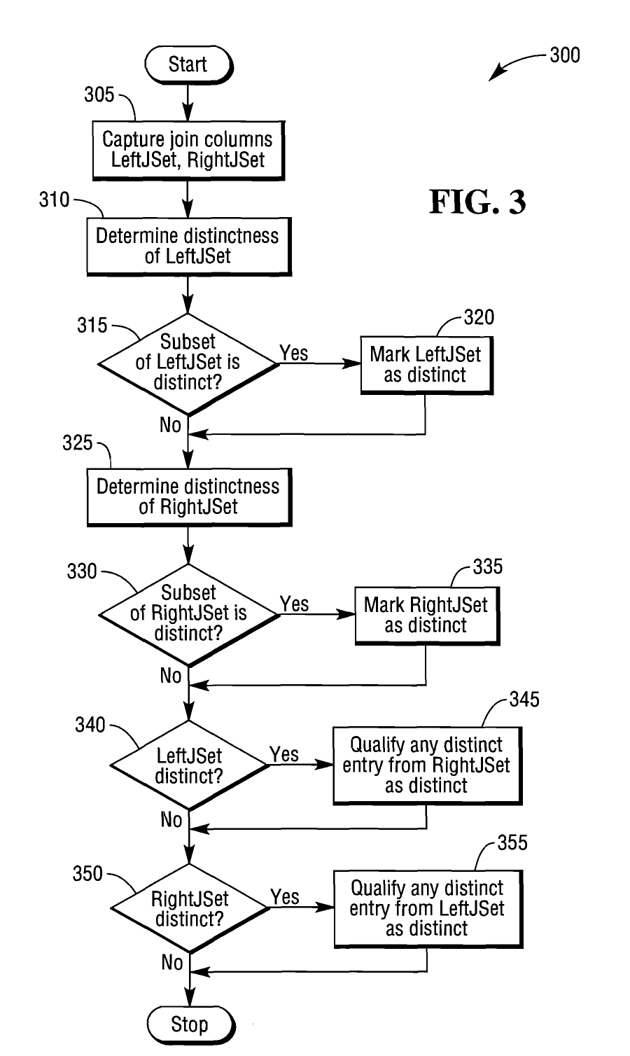

One technique for propagating across joins where applicable is shown in FIG. 3. The first step in the technique 300 is to capture 305 the join columns from the left and right relations. These are referred to as LeftJSet and RightJSet respectively.

The next step is to determine 310 the distinctness of the left relation LeftJSet. If 315 any column or combination of columns that is a subset of left relation LeftJset is distinct, then the LeftJSet is marked 320 as distinct.

The next step is to determine 325 the distinctness of right relation RightJSet.

If 330 any column or combination of columns that is a subset of right relation RightJSet is distinct, then the RightJSet is marked 335 as distinct.

If 340 the left relation LeftJSet has been marked as distinct, then any distinct entry from the right relation qualifies 345 to be distinct after the join. If 350 the right relation RightjSet is distinct, any distinct entry from the left relation qualifies 355 to be distinct after the join.

One example involves:

SELECT*FROM t1, t2 WHERE t1.x1=t2.x2; t1.y1=t2.y2;

Assume t1.x1 is DISTINCT or t1.y1 is DISTINCT or (t1.x1, t1.y1) is DISTINCT.

In the above example all DISTINCT entries from the right are propagated to the join as DISTINCT.

In another example:
SELECT*FROM t1, t2 WHERE t1.x1=t2.x2; t1.y1=t2.y2;

Assume t2.x2 is DISTINCT or t2.y2 is DISTINCT or (t2.x2, t2.y2) is DISTINCT.

All DISTINCT entries from the left are propagated to the join as distinct.

In a further technique the distinct attribute is propagated across query blocks. Examples include spooled derived tables, spooled views and spooled sub queries.

The technique further provides for consumption of the DISTINCT attribute. A first example is:

```
SELECT DISTINCT x1, y1, sumz1
FROM (SELECT x1, y1, sum (z1)
    FROM t1
    GROUP BY 1,2) DT (x1, y1, sumz1).
;
```

In the above example, it is assumed that after the derived table “DT” is processed, the column combination (x1, y1) is marked as DISTINCT in the derived statistics. This information can be used in doing the estimation for the outer block to determine the number of distinct rows for DISTINCT operations. A second example is:

```
SELECT *
FROM (SELECT x1, y1
    FROM t1
    UNION
    SELECT x2, y2
    FROM t2) DT (x1, y1)
    , t3
WHERE DT.x1 = t3.x3
AND DT.y1 = t3.y3;
;
```

In the above example the derived table “DT” is processed. Following processing, the column combination (x1, y1) would be DISTINCT because of the UNIQUE set operation. This information can be used in doing the estimation and costing of the outer block join processing.

Referring back to FIG. 2, augmenting derived statistics 210 is a function that is performed after major operations.

Derived statistics are exposed 215 to the optimizer. One technique for exposing the derived statistics to the optimizer includes propagating the derived statistics across optimization stages. The preferred mechanism for propagation is a flat data structure associated with each relation (base table or intermediate spool table) accessed by the query optimizer. An entry in this flat data structure is made for each base table statistic and from information derived from other sources that is required in the query.

Consider the following multi-blocked query:

SELECT *
FROM t1, (SELECT x2, sum(y2) FROM t2) DT (x2, sumy2)
WHERE t1.x1 = DT.x2;

In this query, the derived statistics from the inner query block names as “DT” are propagated to help the join planning on the outer block that has table “t1”.

As described above each entry contains both static and dynamically adjusted information. This information includes the minimum, maximum and best number of unique values, the number of nulls, high modal frequency, original interval histogram statistics, and a uniqueness flag.

Single column and multi column demographics are propagated within the query blocks. They are also propagated across the spooled query blocks after a derived table or complex view is materialized. This is in addition to a final row count.

The techniques described above for derived statistics are now described with reference to an example. The following table and join index definitions are first used to construct a database system. The query described below shows the flow of derived statistics usage by the optimizer to generate more accurate cardinality estimates. The definitions are as follows:

```
CREATE TABLE t1 (
    a1 INTEGER,
    b1 INTEGER,
    c1 CHARACTER(5),
    d1 DATE);
CREATE TABLE t2 (
    a2 INTEGER PRIMARY KEY,
    b2 INTEGER,
    c2 CHARACTER(1) CHECK (c2 IN (‘M’, ‘F’)),
    d2 DATE);
CREATE TABLE t3 (
    a3 INTEGER,
    b3 INTEGER,
    c3 CHARACTER(5),
    d3 INTEGER);
CREATE JOIN INDEX ji_t1 AS
  (SELECT a1, d1
    FROM t1
    WHERE b1 > 10
    AND c1 = ‘Teradata’);
CREATE JOIN INDEX aji_t3 AS
  (SELECT a3, d3, COUNT(*)
    FROM t3
    WHERE b3 < 100
    GROUP BY 1, 2);
```

Assume the following user query:

```
SELECT *
FROM t1, t2, t3
WHERE b1 > 10
    AND c1 = ‘Teradata’
    AND b3 < 50
    AND d1 = d2
    AND a2 = a3
    AND d2 = d3;
```

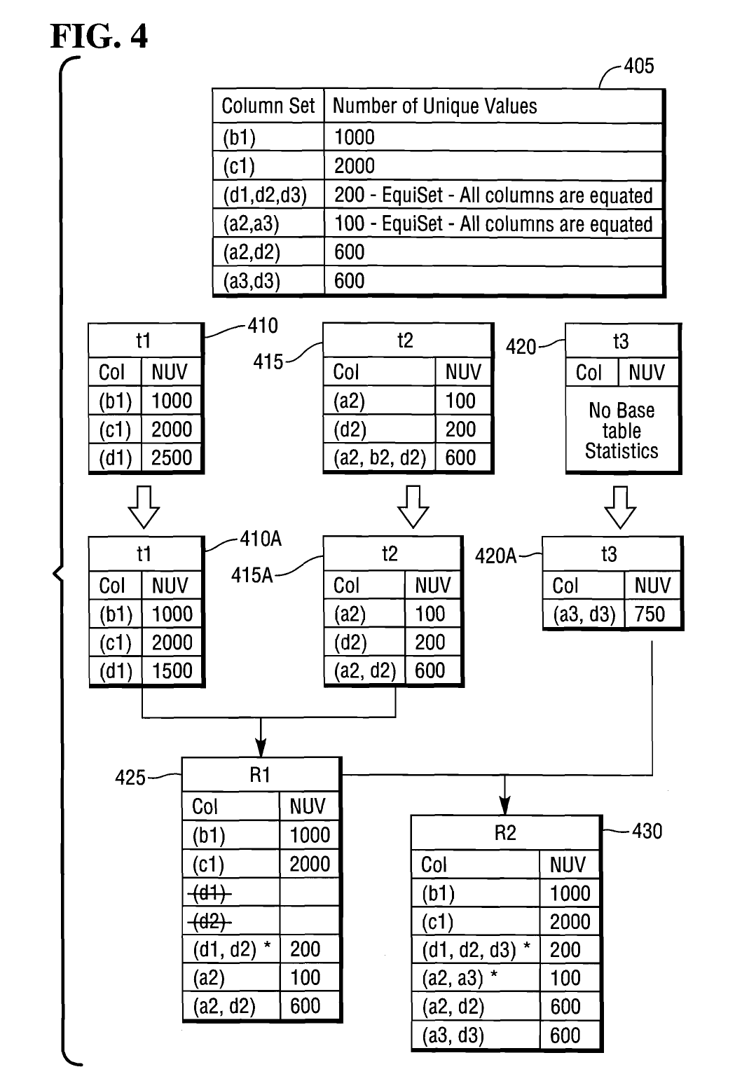

FIG. 4 shows a flowchart illustrating how the optimizer uses derived statistics to more accurately estimate cardinalities for the above query.

The final derived statistics for the above example query are shown at 405. The resulting join relation includes a column set and the number of unique values for that column set. As shown in the figure, columns b1 and c1 have 1,000 and 2,000 unique values respectively. Column (d1, d2, d3) has 200 unique values. This is an equi set in which all columns are equated. Similarly column set (a2, a3) has 100 unique values in which all columns are equated. Column sets (a2, d2) and (a3, d3) both have 600 unique values. The following narration explains how these derived statistics are propagated and derived at each stage.

The statistics for table t1 are shown at 410. Derived statistics 410A are derived from statistics 410 by capping the number of unique values in t1.d1 at 1,500. One technique for this capping is by using the join index statistics from ji_t1 on column d1.

Statistics for table t2 are shown at 415. Derived statistics 415A are based or derived from statistics 415. No statistics have been collected on t2.(a2, d2). However, statistics have been collected on a superset of those statistics. This superset is (a2, b2, d2). The cardinality of that superset (600) is stored in the derived statistics for t2.(a2, d2) and propagated to the next stage of the process.

The initial statistics for table t3 are shown at 420. There are no base table statistics for table t3. To create derived statistics 420A, the statistics for table t3 are inherited from the aggregate join index aji_t3.

Tables t1 and t2 are then joined, consuming the term d1=d2. This produces the interim join relation R1 shown at 425. Since columns d1 and d2 are equated, they merge into an equi set. The equi set represents all the set columns that are equated. The equi set takes the smaller of the two unique value cardinalities as min (200, 1500) namely 200. The entries for d1 and d2 are removed from the derived statistics set.

Interim join relation R1 shown at 425 is then joined with table t3 shown at 420A. This produces the join relation R2 shown at 430. The terms a2=a3 and d2=d3 are consumed. Join relation R2 is the final set of derived statistics cardinalities.

In FIG. 4 the term “COL” represents the column set for which demographics are derived by the derived statistics subsystem. The term “NUV” is the number of unique values for a column set as derived by the derived statistics subsystem.

The techniques described above have the potential to provide an advantage to prior techniques that revert to the original interval histogram with statistics at the beginning of each stage of the optimization process. The techniques described above propagate all newly derived statistics to subsequent phases of optimization. These techniques refine estimates in real-time that greatly reduce the multiplicative error propagation that would otherwise be present.

Another further benefit is the avoidance of often significantly less accurate join cardinality estimates at each stage of the join space analysis. More accurate cardinality estimations achieved with the “derived statistics” techniques have the potential to result in more optimal join plans.

The text above describes one or more specific embodiments of a broader invention. The invention also is carried out in a variety of alternative embodiments and thus is not limited to those described here. Those other embodiments are also within the scope of the following claims.

I claim:

1. A method of maintaining derived statistics within a database system, the method comprising:
associating initial statistical information with at least one relation within the database system;
composing derived statistics involving the at least one relation;
deriving distinctiveness information including at least one relation;
augmenting the derived statistics with the derived distinctiveness information;
associating the derived statistics with the at least one relation; and
exposing the initial statistical information and the derived statistics to a query optimizer.

2. The method of claim 1 wherein composing the derived statistics is performed after applying a single table predicate.

3. The method of claim 1 wherein composing the derived statistics is performed after performing a binary join.

4. The method of claim 1 wherein composing the derived statistics is performed after performing an aggregation.

5. The method of claim 1 further comprising resolving one or more conflicts within the derived statistics.

6. The method of claim 1 further comprising resolving one or more conflicts between the derived statistics and the initial statistical information.

7. The method of claim 1 wherein the initial statistical information is derived from interval histogram statistics.

8. The method of claim 1 wherein at least one of the relations includes a base table.

9. The method of claim 1 wherein at least one of the relations includes an intermediate spool table.

10. The method of claim 1 wherein deriving distinctiveness information is performed after applying a DISTINCT operation.

11. The method of claim 10 further comprising propagating the DISTINCT attribute of a DISTINCT operation across a join.

12. The method of claim 11 further comprising:
capturing the join columns from the left relation; and
marking the set of join columns from the left relation as distinct if one or more columns within the join columns from the left relation are distinct.

13. The method of claim 12 further comprising:
capturing the join columns from the right relation; and
marking the set of join columns from the right relation as distinct if one or more columns within the join columns from the right relation are distinct.

14. The method of claim 13 further comprising qualifying any distinct entry from the right relation as distinct if the set of join columns from the left relation is marked as distinct.

15. The method of claim 13 further comprising qualifying any distinct entry from the left relation as distinct if the set of join columns from the right relation is marked as distinct.

16. The method of claim 1 wherein exposing the derived statistics to the query optimizer further comprises propagating the derived statistics across optimization stages.

17. The method of claim 16 further comprising propagating the derived statistics from an inner query block within a multi-blocked query.

18. A computer readable medium having stored thereon computer executable instructions that when executed on a computing device cause the computing device to perform a method of maintaining derived statistics within a database system, the method comprising:
associating initial statistical information with at least one relation within the database system;
composing derived statistics involving the at least one relation;
deriving distinctiveness information including at least one relation;
augmenting the derived statistics with the derived distinctiveness information;
associating the derived statistics with the at least one relation; and
exposing the initial statistical information and the derived statistics to a query optimizer.
